(19) United States
(12) Patent Application Publication
(10) Pub. No.: US 2010/0318430 A1
(43) Pub. Date: Dec. 16, 2010

(54) OPERATING METHOD FOR SHARED PUBLICITY

(76) Inventor: Jose Carlos Rebelo Norte, Benedita (PT)

Correspondence Address: SUGHRUE MION, PLLC, 2100 PENNSYLVANIA AVENUE, N.W., SUITE 800, WASHINGTON, DC, 20037, US

(21) Appl. No.: 12/599,793

(22) PCT Filed: May 9, 2008
(86) PCT No.: PCT/PT2008/000020

§ 371 Date: Aug. 24, 2010

(30) Foreign Application Priority Data
May 11, 2007 (PT) PT 103737

(51) Int. Cl. G06Q 30/00

(52) U.S. Cl. 705/14.69

(57) ABSTRACT

The following Invention consists of a method and/or channel for distribution, forwarding, management and sharing of contents, space and time by means of support platforms and geographically scattered electronic devices, as well as their validation and broadcasting, making it, therefore, possible for any person, singular or collective, to directly select, advertise, promote and divulge goods, products, services and any type of contents on an individual, local, regional, national, international and global scale, when, where and during whatever time one intends, without needing to resort to third parties on a real time basis or close to it and in legal conformity by their validation.

The following Invention consists of a method and/or channel for distribution, forwarding, management and sharing of contents, such as image and/or sound information, space and time by means of support platforms and geographically scattered electronic devices, as well as their validation and broadcasting, making it, therefore, possible for any person, singular or collective, to directly select, advertise, promote and divulge goods, products, services, contents and information of any kind on an individual, local, regional, national, international and global scale, when, where and during whatever time one intends, without needing to resort to third parties on a real time basis or close to it and in legal conformity by their validation. Furthermore supplying any radio and/or television and/or similar transmitter and/or operator the faculty of simultaneously transmitting differentiated contents to each receiver, or sets of them, without the detriment of their regular broadcast being able to alternate between them whenever it desires, therefore, granting a direct form of sending the right message to the right audience at each moment, at each message and at each audience.

The fore-mentioned method comprises a diverse set of devices capable of receiving regular broadcasts from various transmitters through an open or closed signal, re-transmitting them in real time while receiving and saving contents from each of them and/or from third parties, devices for the analysis of the regular signal for the interruption and recovery of its retransmission, broadcasting devices by total or partial overlapping of the stored contents and the returns devices for the controlling of their broadcasting.

The fore-mentioned method therefore creates the faculty of directing the right information to the right individual, without any interference from him, while simultaneously allowing any other individual to create his contents and put them wherever, whenever.

### Basis

The advances in technology have created a set of new communication media, from which we can highlight the following as examples, publicity and/or informative messages shown in a slide fashion or films on television type screens that make it possible to promote and divulge products and services strategically found near consumers. Even though these devises have some advantages compared to the ones existing before them, for example the printed ones (outdoors, flyers, etc) and the diffusing ones (television, radio, etc), there is a problem that still exists and is common to all: creating, inserting, removing or changing a campaign is always a relatively complicated process, which obviously reflects on the operation's price and conditions the access to this means of communication and diffusion by advertisers and potential advertisers. Out of curiosity, what happens if a certain detail in a campaign needs to be changed: in the printed means' case, a substitution or a physical alteration is necessary, as for the diffusing means, or even these new media, a technical intervention is necessary so that the campaign can reflect the desired change. The same thing obviously happens every time a campaign is entered, launched or substituted. On the other hand, and no matter what the campaign's dimension, format or means of diffusion is, a problem which always comes up is the profitability and returns of the investment made, which without a doubt conditions most of the potential investors and advertisers. Ironically, we could almost claim that a product created to incite an impulsive purchase, does not in fact have this characteristic itself due to the complexity in elaborating a campaign and distributing it out to the several existing media, consequently having high procedure costs due to the distributed nature of all the available media.

Another common, but not less important, problem in all forms of information, publicity, promotion and diffusion, being its means printed, diffusing or any other, including all the new existing media, is the acquisition, creation, legality, profitability and content of the content itself.

On the other hand, the same advancements in technology have, over time, made the traditional media, such as radio and/or television, a form of communication by excellence, global and universal, represented nowadays in most, if not all, homes, commercial areas, public and private and even leisure areas, being inclusively represented in vehicles and cell phones, influencing and transforming humanity's way of life on a scale never seen before. But even these types of media, in this day and age, come across adverse situations, as a result of their own universalistic nature. In other words, considering that these media are not able to differentiate the messages they have to diffuse per receiver and/or sets of them, and consequently per reached target-public, they are an extremely onerous form of communication, only available to huge investors, while dissipating resources by not being able to distribute and/or fit each sent message to the respective audiences, which are somehow, predisposed to receiving them. Nowadays, these types of matters are causing the investors, such as publicists and akin, to side-track to other media, such as the Internet, so as to select more rigorously the audiences that they aim to reach. In a certain way, it is ironic that the main attribute, that made these media what they are today, is at the same time what is slowly dispersing the same investors.

Another problem inherent to the fact of us being in the presence of mass diffusing media is the distribution of contents' high cost, causing these to only be within a small elite of investors' reach.

Yet another problem intrinsic to the global nature of the traditional communication media, such as the radio and/or television, is related to the fact of the diffusion being transmitted by means of only one signal, containing only one message at each time, retransmitted universally to all the receptors, not allowing an efficient differentiation and/or correlation of the diffused messages over the different reached audiences, clearly limiting their impact. Even with the advent and generalization of the digital and/or interactive television with the capability of multiple broadcasts, where two or more programmes can be shared on the band's width, usually used by a single analogical programme, the same problem persists: the transmitter does not have an active role, i.e. automatic, intelligent, dynamic and transparent, of adapting and/or selecting the contents to be diffused among the diverse audiences, limiting itself to only supplying more services and/or contents to them in a passive form, leaving the control in each individual or viewer's hand, expecting from him any action such as “press here”.

Yet another problem, which in a certain way, prevents the open-access of these means to the world, is, once again, the attainment, creation, legality and content of the contents themselves, due to the explosion of advertisers and/or content creators and, obviously, of contents whose open-access to the world entails. Making it possible for anyone to be side by side with the huge and traditional advertisers and/or communicators, using the same means as these, and allowing them to make their message reach any point on the globe, brings about a series of new problems, implicating, compulsorily, a rigorous control of the contents fitted in the respective places, i.e. localities and audiences to which they are destined. This control and validation is obviously only executable in an automatic and distributed way, on pain of making the mentioned access of these means to individuals in general impracticable, due to the gigantic size of information generated by them.

From the already mentioned problems, and many others could be enumerated, an obvious conclusion comes up, these communication, publicity and/or diffusion media are a working tool and a way of generating wealth, which on one hand is not available to everyone, and on the other hand do not have, in their genesis, an efficient and pro-active way of doing so. In other words, these media are imprisoned and limited to the fact of the present technology not allowing the diffusion and/or adaption of the emitted signal to the various universes of receptors syntonized, i.e. tunned, on them.

Without intending to be limitative, one of the Invention's aims is the conception of a device in a café which has the capability of broadcasting and/or transmitting texts, graphics, sounds, images or films and/or any combination of any of these in an exclusive manner, or by splitting time with any other procedure or aim for which it was meant (for example: screen, television, computer, outlet, multimedia kiosk, Internet spot, etc). Due to this device's privileged position, close to the local consumers, and due to the fact that it is in a place of leisure, that they themselves chose, it therefore becomes by excellence a means of communication for the local traders and for the neighbouring community. Without the detriment of proximity, the regional, national or international operators also have simultaneously, in the same place, a high potential of target clients. In this setting it is easy to understand the significance that the incorporation of the Invention will bring about in the local market, as well as in any other market, by allowing the devices described above to start functioning as an information diffusion channel and by simultaneously creating the processes and the methods so that anybody or any entity can make their informative and/or publicity contents reach the devices mentioned above in a completely automatic way from any place, while simultaneously undertaking the whole process of validating them in order to guarantee their legitimacy and legality on a local and global level, of easy access and sharing resources implicating a significant impact on the costs involved.

In another aim, the method makes a means available for any individual to promote contents of his authorship, by directly selecting the place or places where he intends to put them, making himself his own campaign manager.

In another aim, the method gives any advertising or informative and/or publicity content creation agency a list of all viewing spots, their characteristics and potential clients. Consequently drastically accelerating the process of selecting target markets, as well as directly granting their placing “on air” on a real time basis or close to it, and the thorough control of their state, cost, maintenance and adjustment also on a real time basis or close to it.

In yet another aim, the method makes a channel for the validation of informative and/or publicity contents on a global scale available, by supplying the tool that permits the validation of any content as well as its own feedback prior to its launching in the market.

In yet another aim, the method provides other systems the possibility of accessing a global database of viewing spots, target public reached, i.e. the receivers and their characteristics, advertisers and campaigns that are taking or have taken place, allowing, inclusively, the interconnection or integration with them.

In yet another aim, and also without prejudice to all and any other configuration, let us take as an example a television set in a public space, private space, or inclusively in any room in any house and, also without prejudice to any other situation, let us take as an example the commercial break of any live broadcast, sports programme, film, news broadcast and/or any other transmitted by a television station. Based on the above, we can safely declare that the conditions to make a certain message reach a gigantic and diverse universe of viewers and/or consumers of the message itself are assembled. However, and without questioning any advantage that this type of media presents nowadays, a contradiction immediately comes up from the presuppositions: while the universe of the message's viewers and/or consumers is diverse in the most distinct forms (for example: region, age group, preferences, interests, social status, type, setting, locality, etc.), the message itself is not. On the contrary it is unique and universal at each and every moment. In this context it is easy to understand the benefits that this Invention's incorporation will bring about by allowing the transmitting stations to select the contents and/or messages to be diffused, during the mentioned commercial break, not in a unique and universal way, but rather differentiated and/or adapted by each, and for each, receptor and/or sets of them. In other words, send the right message to the right target public, in an intelligent, automatic and completely transparent way. To exemplify, it is enough to observe the impact produced in each viewer, during the mentioned break, when exposed not to general-interest and universal contents, but rather to personalized contents, that he is somehow predisposed to receive (for example: regional, of proximity, age group, etc.), then returning, at the end of the break, and also in a completely automatic way, to the programme, i.e. occurring programming so that the benefit of the Invention's incorporation may stand out immediately.

In another aim, the method makes a means available so that any transmitter can switch from a national and/or global broadcast to a local one, differentiated by receptor or sets of them, and vice-versa whenever it wants, in a completely automatic way, and nevertheless without affecting its regular global broadcast.

These and other advantages of the Invention will be easier understood in the enclosed diagrams mentioned below, in their brief description and in the detailed description of the method itself, as well as many others that occur due to the Invention or due to the incorporation of part or parts of it.

### BRIEF DESCRIPTION OF THE DIAGRAMS

The description that follows is based on the attached diagrams, which without any claiming character represent:

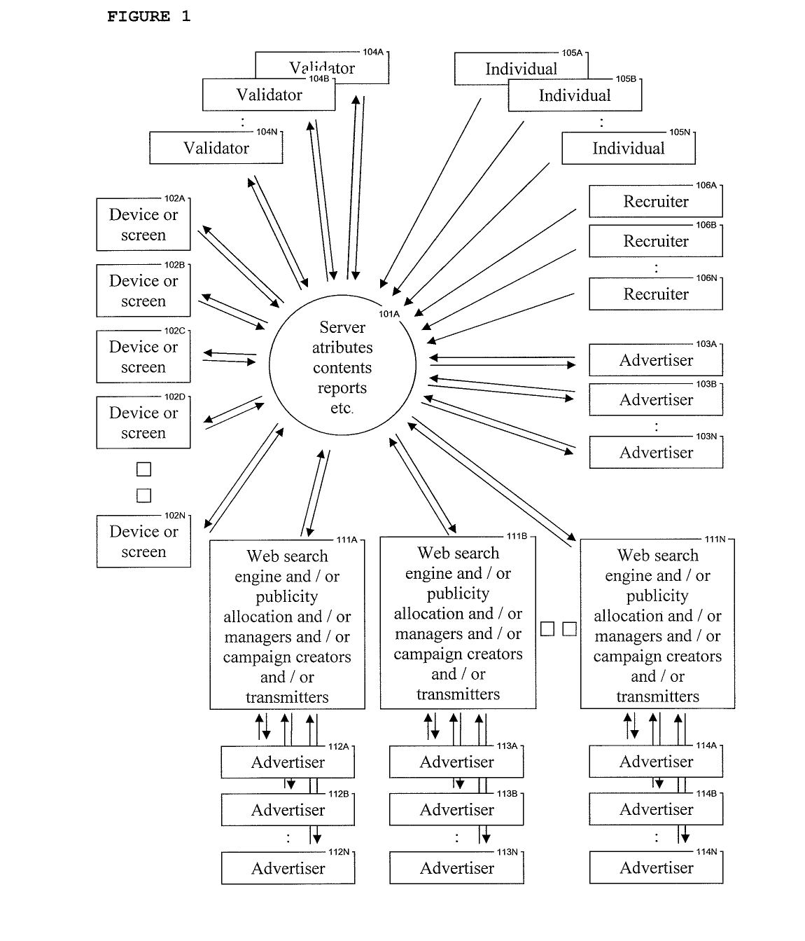

FIG. 1 is a block diagram that illustrates the main components, as well as the several intervenients in the process of recruitment, validation, broadcasting, information and contents flow of a system according to the Invention.

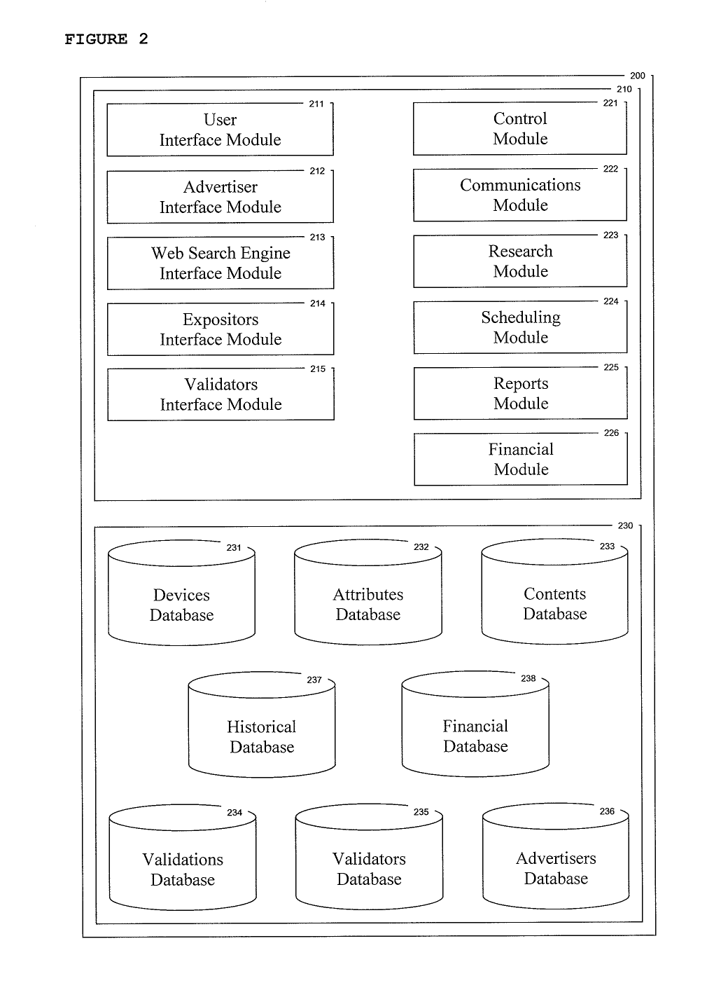

FIG. 2 is a block diagram that illustrates the main modules and components of a system's central server according to the Invention.

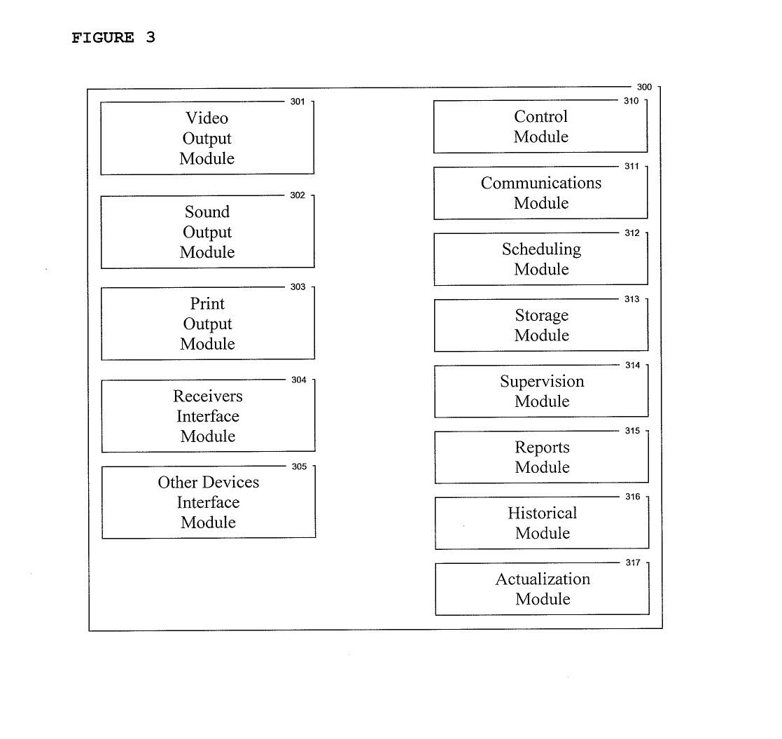

FIG. 3 is a block diagram that illustrates the main modules and components of a system's generic client, i.e. device, according to the Invention.

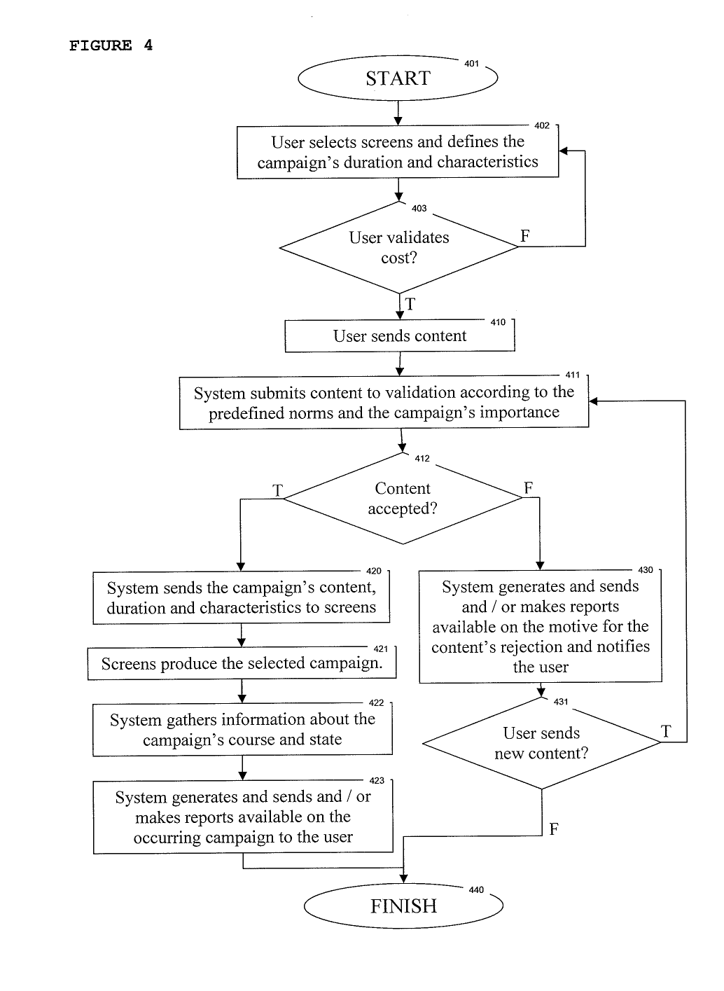

FIG. 4 is a flow diagram that illustrates the system's general conception from the selection process to the returning of reports, passing through the validation, broadcasting and treatment of exceptions according to the Invention.

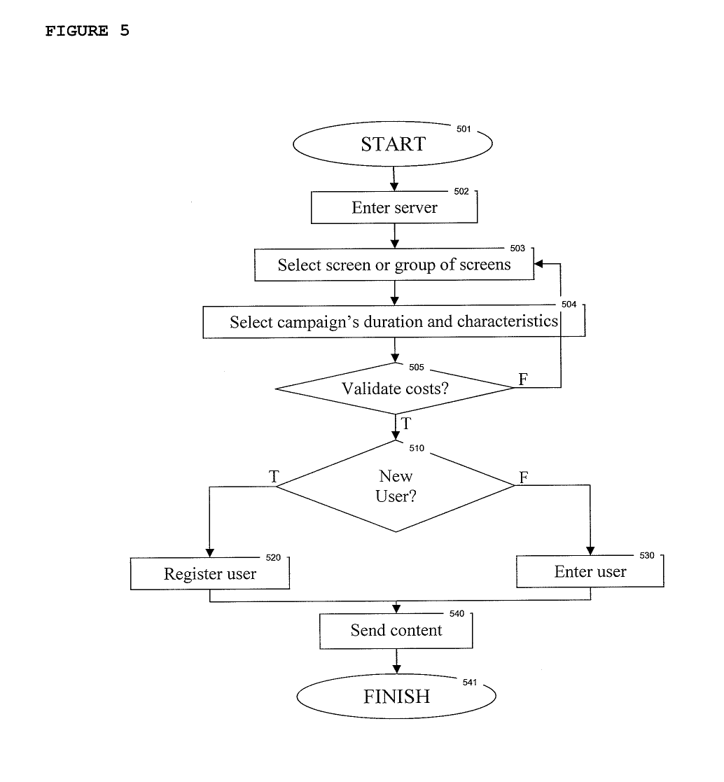

FIG. 5 is a flow diagram that illustrates the selection of the devices, the acceptance and the sending of contents from the user to the central system according to the Invention.

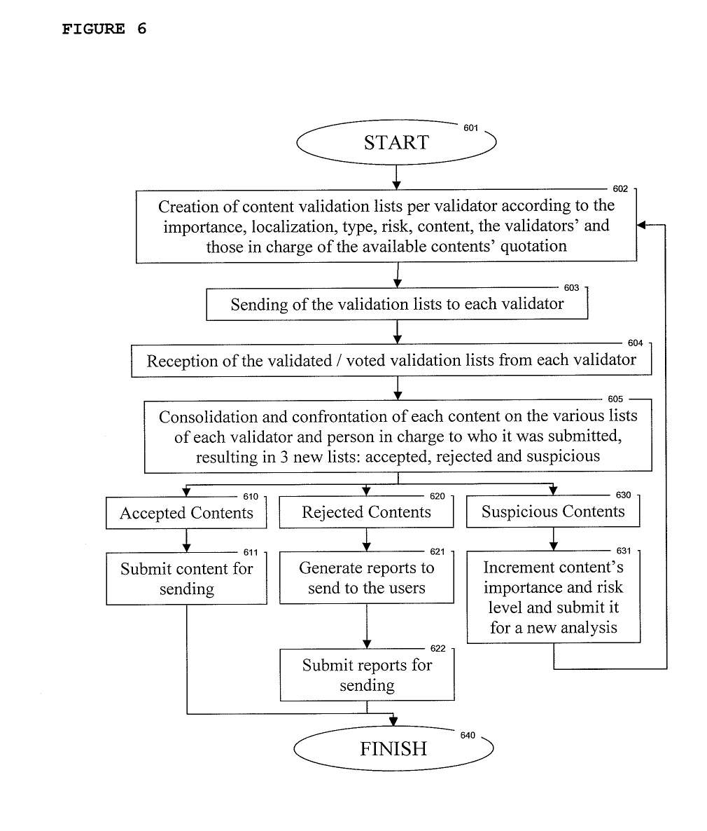

FIG. 6 is a flow diagram that illustrates the analysis and consolidation of the validation of contents lists by the central system in order to filter their content according to the Invention.

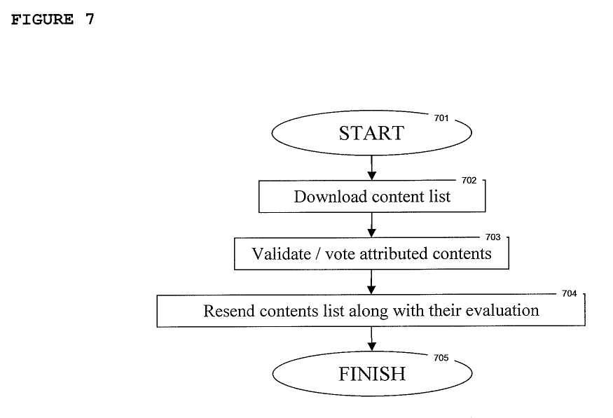

FIG. 7 is a flow diagram that illustrates the reception, validation and sending of contents by the validators in order to allow the central system to create an acceptance list based on each of their votes according to the Invention.

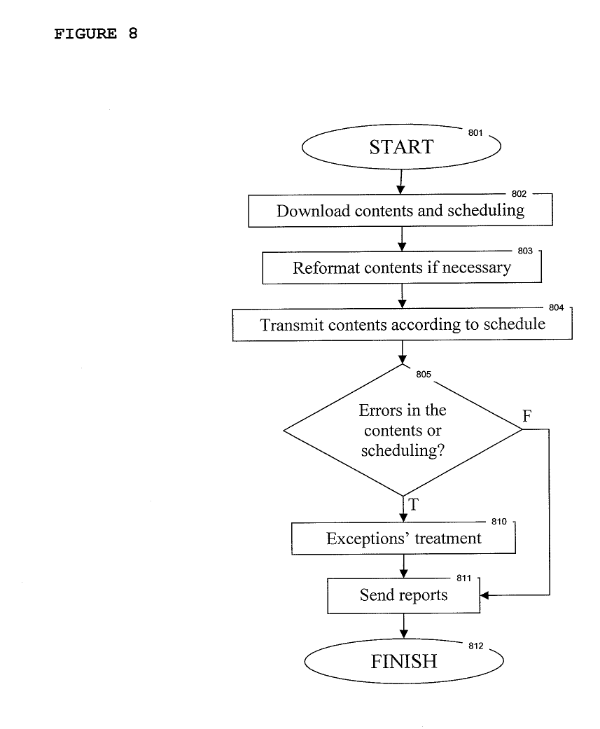

FIG. 8 is a flow diagram that illustrates the devices' reception, content processing and returning according to the Invention.

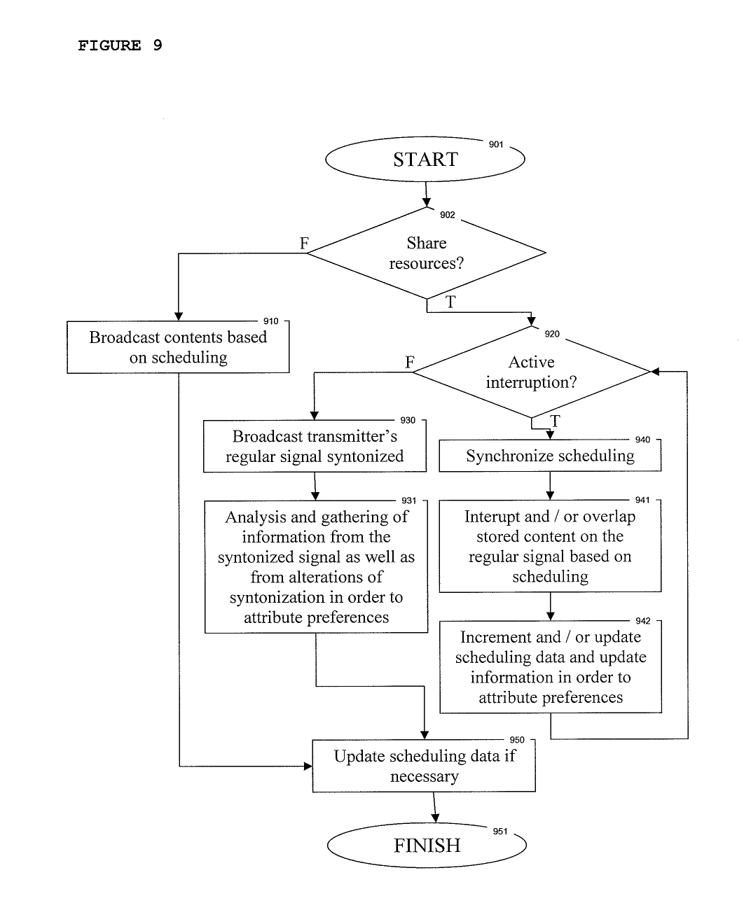

FIG. 9 is a flow diagram that illustrates the broadcasting of contents by the devices according to the Invention.

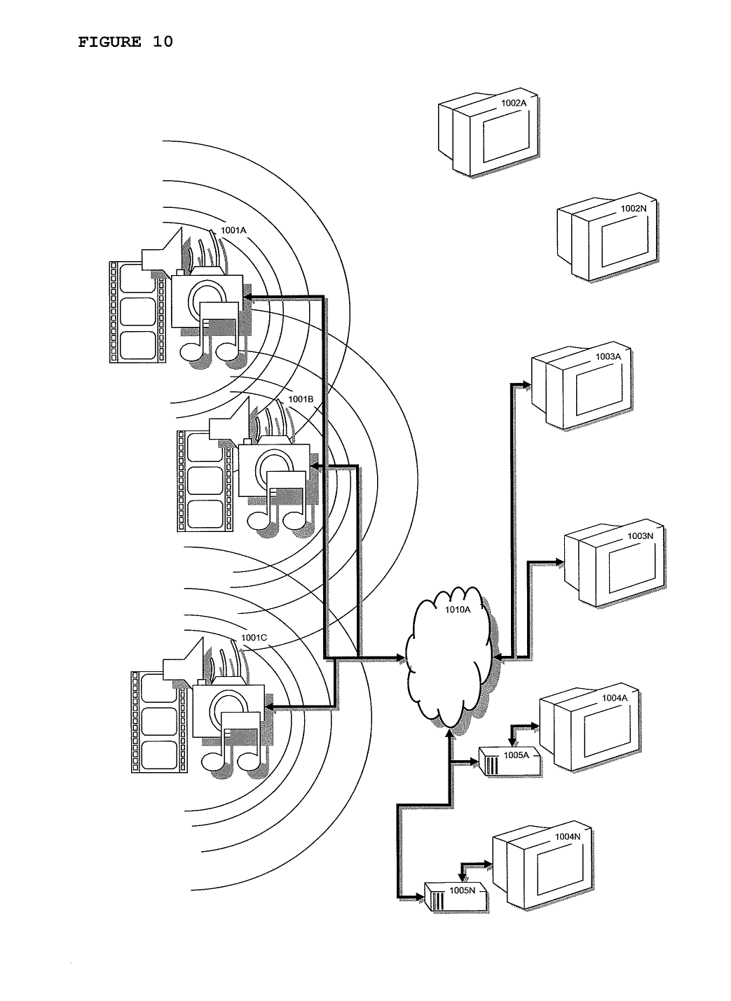

FIG. 10 is a diagram that demonstrates the method and its functioning adapted to one or more radio and/or television transmitters that shares resources with these.

### DETAILED DESCRIPTION

### Global View

Concentrating on FIG. 1, an example of the Invention's incorporation would be a series of electronic devices (102A . . . N) geographically scattered over the globe and linked between themselves to a central server (101A). This connection may be brought about with a public network, such as the Internet, or a private network, such as W-Lan, and/or a mixed network of any kind. The server (101A) mentioned above, would also be available in that or in any other public network so as to be accessed from any part of the globe, supplying and operating as an access channel to the system as a whole and being responsible for the system's own management.

Each of these devices, (102A . . . N), geographically scattered will have the mission of communicating with the server (101A) and receiving from it a list of contents and schedules, i.e. transmission orders, such as, date, time, channel, index and/or synchronization number for interruption, programming, setting, etc., going on to its broadcasting, sharing space, time and resources with their other present and scheduled contents and all and whatever function they are predestined for. From its broadcasting, a number of reports result, such as, for example, the number of viewings, the periodicity, the campaign's state and in some cases the impact on the target public. Resortion to the automatic or manual reading of cash registers, POS's, interaction through touch-screen systems, keyboards, mice, remote controls, sample dispensers, audience surveyors, etc., that are at the scene, may be used for such. These and other reports will be sent to the central system, becoming accessible for the intervenients to consult and analyze.

On the other hand, server (101A) is responsible for managing the whole range of devices (102A . . . N) linked to it, as well as creating and maintaining a communication channel between the users (103A . . . N), (105A . . . N), (106A . . . N), (111A . . . N) and the devices (102A . . . N). Other than the management of the channel itself, the server (101A) is also responsible for the whole management and validation of contents, this validation is carried out by the validators (104A . . . N).

Still according to FIG. 1, and through the server (101A), the users (105A . . . N), (106A . . . N), (111A . . . N) have a list at their disposal with geographically scattered devices (102A . . . N), as well as their characteristics, such as their type, region, activity, branch of business, timetable, capacity, setting, surrounding area, projection, GPS coordinates, number of passers-by, customers' or receiver's, i.e. the message's observers, etc., age group, using texts, images, sound and/or audiovisual resources for that.

These lists can themselves be redistributed by each of the users (111A . . . N) by their own users and/or advertisers (112A . . . N), (113A . . . N), (114A . . . N) in order to allow these to also have access to and make use of the system.

The users (105A . . . N), (106A . . . N), (111A . . . N) can send contents to the server (101A) and select on which devices (102A . . . N), or sets of them, they should be broadcasted and their schedule. From this moment on, they are considered by the system as advertisers type (103A . . . N), or type (112A . . . N), (113A . . . N), (114A . . . N), depending on the case.

The contents sent by the advertisers (103A . . . N), (112A . . . N), (113A . . . N), (114A . . . N) to the server (101A) are then submitted to validation by the voting to the validators (104A . . . N). Their number and type is automatically selected in direct correspondence with the relevance of the campaign, obtained from the number of selected devices, their geographical localization, their setting and the type of advertiser at hand and/or content to broadcast.

As soon as the validation lists sent to the validators (104A . . . N) are voted on, they are then resent to the server (101A) and from their junction new lists containing the validated, invalidated and suspicious contents are created. One or more databases are created and maintained for future needs of reusing validated and invalidated contents, and for the eventual creation of contents' and advertisers' “black lists” and/or “white lists”, that can be used to simplify the validation process.

The validated lists are then sent by the server (101A) to the devices (102A . . . N) according to the advertisers' (103A . . . N), (112A . . . N), (113A . . . N), (114A . . . N) selection.

The invalidated lists are reported by the server (101A) to the respective advertisers (103A . . . N), (112A . . . N), (113A . . . N), (114A . . . N) so that the problem or problems found may be corrected.

The suspicious lists, i.e., those that did not meet the validators' (104A . . . N) consensus are once again submitted to validation for a new and more rigorous vote in order to become validated or invalidated. This process will be repeated as many times as required until a consensus is reached or until the highest level in terms of the validation's rigorousness is achieved. If the highest level is reached without a consensus, the list is automatically invalidated. In each iteration, the risk level is incremented, as well as the selected validators' (104A . . . N) level.

As soon as the lists with the validated contents in each device (102A . . . N) are received, these are broadcasted according to the procedures which were assigned, i.e. scheduled, to them and reports on the state and course of the campaign are simultaneously elaborated, which will then be sent back to the server (101A), which will guarantee that they are made available to the respective advertisers (103A . . . N), (112A . . . N), (113A . . . N), (114A . . . N).

As soon as the reports are received by the advertisers (103A . . . N), (112A . . . N), (113A . . . N), (114A . . . N), these come about a series of information and tools that allow them to consult and react to the obtained results, in order to maximize the campaign at hand's impact and profitability, by changing, modifying, cancelling or dislocating their campaign or campaigns on a real time basis or close to it.

Note that in FIG. 1 only one server (101A) is illustrated. This should be strictly understood as an example since many other incorporations may have two or more servers (101A), connected together by means of a network. However, this set of servers (101A) work together in cooperation as one in a totally transparent way for the whole system.

The devices (102A . . . N) may comprise LCD screens, PLASMA screens, CRT screens, projectors, holographic projectors, indoor or outdoor systems, include speakers and/or any other sound system, as well as any other image broadcasting system. In other cases they may also incorporate systems of interaction with the receivers, such as touch-screen systems, keyboards, mice, printers, printed incentives or sample products. In yet other systems they may include radio frequency modules, infra-reds, Bluetooth or laser in order to interact directly with the receivers. In yet other systems they may allow interaction with cell phones, palms or other devices belonging to the receivers, receiving and providing information about the broadcasted contents. In yet other incorporations these may have connections to automatic or manual vending systems and automatic or manual access to cash register systems or POS's installed on the premises to assemble the effectiveness generated by the diffused message. In yet other incorporations these devices may in fact be the cash registers, POS's, multimedia kiosks or Internet access spots themselves, sharing resources with them. In yet other incorporations these devices may be traditional television screens and/or boxes and/or sets of these sharing broadcasting space and time with the syntonized television operator's regular emission using, in this case, audiovisual signals not perceptive to mankind (for example, non-audible acoustic signals, teletext, the non-used band width, etc), enclosed in the signal emitted by the operator, for the transition, interruption and recovery between the broadcasting modes (for example, a live signal vs. this signal's total or partial overlapping by a stored signal).

In the Invention's most diverse incorporations, the content may include texts, graphics, sounds, images (static or dynamic), films, prints, Web pages, e-mails or any combination of any of these, depending on the capabilities and characteristics of each device (102A . . . N). The content may in fact suffer changes depending on the selected devices' characteristics. This content should not nevertheless be restricted to the given examples, but rather be understood so as to include all forms of products' and/or goods' and/or services' promotion at a person's disposal.

### Central Server

Focusing on FIG. 2, a block diagram which illustrates the different modules (210) and databases (230) that incorporate the server (101A) (200).

A user's interface module (211) which allows any person to consult the devices' (102A . . . N) lists, their characteristics (for example, locality, setting, age group, audience, etc.), select those that are of his interest and simulate a campaign on them.

An advertiser's interface module (212) which allows the advertisers (103A . . . N), (112A . . . N), (113A . . . N), (114A . . . N) to insert new campaigns, consult, change, remove occurring campaigns and/or consult reports on them.

A Web search engine's interface module (213) which allows other systems to connect and/or integrate the method itself as if they are a part of it.

An expositors interface module (214) which allows the devices' (102A . . . N) owners or lodgers to consult the occurring campaigns on their own devices.

A validators (104A . . . N) (215) interface module which allows the registered users and those accepted as such to access to the validation lists compatible with each of them and/or to their lists and to proceed to the validation by voting on them.

A control module (221) which has the responsibility of managing the process as a whole.

A communications module (222) which controls the communications, distribution of contents, distribution of schedules and gathering of reports from all the devices (102A . . . N).

A research module (223) which allows the research and access of all databases and simultaneously provides the auxiliary tools for the selection of devices, contents, research of the history records and advertisers.

A scheduling module (224) which controls the scheduling of all the devices (102A . . . N) and the collisions between themselves.

A report module (225) which organises and distributes all the reports received from the devices (102A . . . N) by their own intervenients.

A financial module (226), which controls the financial flux between all of the intervenients in the process, receiving and making payments among them.

A devices' database (231) with all the devices (102A . . . N) and their characteristics.

An attributes' database (232) with all the devices' (102A . . . N) attributes, locality and characteristics of their surroundings.

A contents database (233) where all the advertisers' (103A . . . N), (112A . . . N), (113A . . . N), (114A . . . N) or users' (105A . . . N), (106A . . . N) sent contents are stored.

A validations' database (234) where all the validators' (104A . . . N) made validations are stored.

A validators' database (235) where all the validators (104A . . . N) and their characteristics are stored.

An advertisers' database (236) where all the data referring to the advertisers is stored.

A historic database (237) used to store, consult and analyse past campaigns.

A financial database (238) where each intervenients' account is created and kept, from the advertisers to the exhibitors, including the validators and all the intervenient users in the process.

### Generic Device

FIG. 3 is a block diagram which illustrates the various modules (300) of a device (102A . . . N). Depending on the type of device (102A . . . N) at hand, it may include part of or all of the mentioned modules.

A video output module (301) which allows the emission of static, dynamic or any other type of images, including holographic images.

An audio output module (302) which allows the emission of sounds, music or any other acoustic form.

A print output module (303) which allows the emission of coupons or of another incentive, on paper or any other material form.

A receivers interface module (304) which allows these to interact with the device (102A . . . N), providing or gathering any kind of additional information.

An interface with other devices module (305) which allows the device (102A . . . N) to communicate with the receivers' devices, such as cell phones or devices that exist on site, for example cash registers, providing or receiving additional information, depending on the case, in order to maximize the impact on the receivers as well as the information returned to the advertisers (103A . . . N), (112A . . . N), (113A . . . N), (114A . . . N).

A control module (310) which is responsible for all the management, processing and functioning of the device (102A . . . N). This module, when that is the case, also handles the sharing of resources' management with other functions for which the device is destined (for example, the interruption of the regular signal on a traditional television by a stored signal and vice-versa).

A communications module (311) which controls the communications, content reception, scheduling reception and sending of reports to and from the server (101A). This module also allows the devices (102A . . . N) to function in collaboration with the server (101A) in the distribution of contents and schedules in a distributed manner, functioning as content and schedule repositories, re-distributing these to other devices (102A . . . N). This module also allows the creation of devices' (102A . . . N) sub networks that also function in collaboration with the server (101A).

A scheduling module (312) which controls the received schedules, guaranteeing that these are processed in the correct manner. This module functions in direct cooperation with the control module (310) in order to guarantee not only that the schedules are guaranteed, but also that in the cases of shared resources (for example, normal television, radio, etc.) these are synchronized with the occurring transition, interruption and recovery signals and/or their absence.

A storage module (313) which functions as a repository of contents and received schedules.

A supervision module (314) which allows certain special control actions on the device, for example its activation in the system, forced stop due to inconformity of contents, and other actions inherent to the device's physical functioning.

A reports module (315) which generates and sends all the reports to the server (101A).

A historical module (316) which stores all of the other modules' generated events in order to keep the device's own historical record.

An actualization module (317) which allows the devise to update the information it contains, as well as itself if necessary.

### Conception

Focusing on FIG. 4, a flux diagram, which illustrates the process and the conception of the method, we can observe an example of the Invention's incorporation. Firstly, one must note that this example is nothing more than an example, and does not intend to limit the Invention or any of its parts to it. In order to be more coherent, in this example, some presuppositions are included and simplified, such as the characteristics of the devices used, so as to clarify as much as possible the systems and the methods used in the Invention.

As we can observe in FIG. 1, a varied set of devices (102A . . . N), that in this particular example are admitted as television screens, which are at a user's (105A . . . N), (106A . . . N) disposal by means of an access portal to the central server (101A), where the user will have access to each device's (102A . . . N) detailed list, its characteristics and current state. This list, as referred before, may have texts, images or audiovisual resources, as well as research and support systems in order to help the user to select the devices (102A . . . N) that are of his interest (402).

As soon as the devices (102A . . . N), and the campaign's time duration are selected, the server (101A) informs the user (105A . . . N), (106A . . . N) of the associated cost and asks for the user's (105A . . . N), (106A . . . N) confirmation (403).

Once the user (105A . . . N), (106A . . . N) validates the operation cost, he sends the content to the server (101A) (410). From this moment on, the system considers the user as an advertiser (103A . . . N).

During regular time intervals, or immediately, depending on the case, the campaign's importance or action to be carried out (inserting, changing, removing, etc), the server (101A) generates contents lists and submits them to the validators' (104A . . . N) voting. The number, type of validators (104A . . . N) and the validators themselves (104A . . . N) selected by the system depend on the campaign's importance and on the proximity, affinity, sensibility, age group, type, qualifications, language, etc., among contents, devices and validators, being proportional to the number of devices (102A . . . N) selected, their locality and the campaign's duration, so as to guarantee the contents' correct setting (411). From the conjunction of the validations and once each content is classified, this content can take two different paths (412).

If a content is rejected, the server (101A) lets the respective advertiser (103A . . . N) know the reasons for this rejection (430), providing him with the possibility of sending a new content or cancelling the campaign (431).

If a content is accepted, the server (101A) sends the content, duration, scheduling and campaign characteristics to the selected devices (102A . . . N) (420).

The selected devices (102A . . . N) dispatch the campaign according to schedule (421) and simultaneously supply and send the campaign's state and course to the server (101A) (422).

The server (101A) gathers, generates, sends and/or makes accessible the convenient individual reports on the state of each occurring campaign, supplying this information to the respective advertisers (103A . . . N) (423).

### The Selection of Devices and Dispatch of Contents

Focusing on FIG. 5, the processes and methods related to the selection and dispatch of contents are observable in more detail.

A user accesses the server (101A) (502) by means of a site or access portal and selects one or more devices (102A . . . N) of his interest (503). This selection is aided by a diverse number of research tools that include, among others, their and each of their surroundings' characteristics. These may include text, sounds and/or static and/or dynamic images. Other than the devices (102A . . . N) the user should select the duration and characteristics of the desired campaign, as well as fit its content (504).

Once the devices (102A . . . N), the campaign's duration and characteristics have been selected, the server (101A) simulates its inherent cost and waits for the user's reply (505).

If the user does not validate the campaign's cost, it is automatically resent for a new selection or for its revision.

If the user validates the cost, the server (101A) requests his personal information (510) in order to register it and/or grants access to his exclusive area depending if he is a new user (520) or an already existing one (530).

Once the access to the user's exclusive area is granted, he can send his contents to the server (101A) and/or select from those previously sent by him and/or marked as public in the server's (101A) contents database (540).

Note that the user can at any time abort the process, which, only for simplifying reasons, is not explicit in this diagram.

### Analysis and Consolidation of Validations

Focusing on FIG. 6, the processes and methods related to the analysis and consolidation of the contents' validation are observable in more detail.

A risk degree is attributed according to the campaign's importance, which is calculated by, but not only, the conjunction of its characteristics, such as the number of selected devices (102A . . . N), their geographical localization, setting, visibility, target public, attributes, etc. Validation lists are created from the risk degree containing the contents to be validated and the groups of compatible validators selected among the validators (104A . . . N) available for each list (602).

These lists are sent or made available by the server (101A) to the respective validators (104A . . . N) (603) so that these may pronounce themselves about the conformity of each of the contents on the list and about the conformity of the setting brought about by the advertiser.

Each of the voted lists and/or contents is then returned to the server (101A) by the validators (104A . . . N) (604).

The server (101A) then advances to the consolidation of each of the received list's contents in order to find or not a consensus for each of the mentioned contents (605). From this consolidation, three new contents lists emerge, containing the accepted contents (610), the rejected ones (620) and the suspicious ones (630). A content is considered accepted or rejected if a consensus in one or another direction is reached and it is considered suspicious if a consensus in neither of the two earlier mentioned directions is reached. The result of each content's consolidation is then confronted with each validator's individual selection in order to increase or decrease each validator's trustworthiness and/or risk level and their skills.

The accepted contents are then submitted for dispatch to the devices (102A . . . N).

The rejected contents are catalogued as so and reports are generated with the reasons for the validators' (104A . . . N) rejection (621) and sent to the respective advertisers (103A . . . N), (112A . . . N), (113A . . . N), (114A . . . N) (622) so that these take the necessary measures and/or make the necessary corrections, by sending new contents, changing or aborting the campaign.

The suspicious contents suffer a risk level increment (631) and are re-submitted for validation according to their new risk level. This process is automatically repeated until a consensus in one of the other two directions is reached or if the risk level reaches the maximum predefined value, in which case the content is immediately considered rejected.

### Validation and Voting

Focusing on FIG. 7, the processes and methods related to the validation and voting of contents are observable in more detail.

The validation based on the voting of contents consists in the server (101A) making the validation lists, along with the respective contents and settings, reach or be available to the respective validators (104A . . . N) (702). The validators proceed to viewing and pronouncing themselves on them, by accepting or rejecting them, or by not pronouncing themselves on each of the contents on their lists. In these two last cases, they indicate the reasons for their choice (703). These same lists are now returned to the server (101A) together with each validators' (104A . . . N) individual vote (704) so that the mentioned server (101A) can conclude the validation process by confronting the different validators' (104A . . . N) validations for the same content according to the validation process.

### Reception and Processing

Focusing on FIG. 8, the processes and methods related to the reception and processing of contents are observable in more detail.

Each device (102A . . . N) connects itself automatically in predefined time intervals to the server (101A), downloading from it, or from who the server indicates, the respective contents and schedules (802).

If necessary and if the server (101A) has not contemplated this yet, the device (102A . . . N) itself can make adjustments to the contents according to its own physical characteristics (803).

The device (102A . . . N) broadcasts the contents based on their schedules (804), sharing space, time and resources among themselves, according to the respective schedules. Note that the broadcasting of contents should be understood in its embracing form within the Invention's spirit, and not as a simple image and/or sound transmission, being, in fact, capable of contemplating interaction with the receivers and/or other third-party devices also within the Invention's spirit. Also note that the sharing of space, time and resources should be understood in its embracing form within the spirit of the Invention, such as, but not only, the temporary interruption and/or temporary, total or partial overlapping of the regular signal on a normal television emission, turning into stored signal, as scheduled.

If due to the broadcasting of the contents or to the scheduling itself, errors occur (805) these are treated by the device (102A . . . N) as exceptions (810) and reports about them are generated.

The device generates reports about all the correctly processed broadcasts and about any other type of information that results from the interaction with receivers or third-party devices, to which it also attaches those that resulted from the treatment of exceptions and sends (811) them to the server (101A) so that it can forward them to the various intervenients according to each report.

### Broadcasting

Focusing on FIG. 9, the processes and methods related to the broadcasting of contents are observable in more detail.

The broadcasting of contents is processed in each device (102A . . . N) in one of two possible modes, i.e., either in an exclusive regime (910) or in a sharing of resources regime (920). This mode is defined for each device (102A . . . N), being part of their physical characteristics.

If a certain device (102A . . . N) is in an exclusive regime, it transmits the stored contents continuously, according to the respective scheduling, without interruptions or sharing with any other aim other than following its own scheduling. Note, nevertheless, that the scheduling may suspend, activate, deactivate and/or restart the broadcasting if such was defined, and/or resort to audience surveyors for the same purpose.

In this mode, and for each of the respective broadcasts, the device gathers and saves the current state, the point where it is, the success or failure, in order to guarantee that the schedule is kept to and the broadcasting is well accomplished (950).

If a certain device (102A . . . N) is in a sharing of resources regime, it continuously tests the received signal, i.e. syntonized, to detect interruption signals included in it (920), (via teletext, non audible acoustic sounds, additional information on the non-used band's width, etc.).

If no interruption signal is active, the device (102A . . . N) transmits the content of the regular signal (930) normally, being able to simultaneously gather information on it (931), such as the syntonized channel, programming, type of programme, content, etc., in order to define and attribute preferences, so that these may be used, in the future, in the selection of the type of contents to be sent.

If an interruption signal is active, the device (102A . . . N) automatically synchronizes its scheduling (940) with the syntonized channel in order to concur with the occurring transmission, interrupting and/or overlapping the stored contents on the regular received signal (941), in conformity with its scheduling (942) for that channel, by resorting to the information held in the interruption signal (for example, via teletext, non audible acoustic sounds, information on the non-used band's width, etc.) to synchronize with it (for example, channel, interruption number, date, time, etc.) or by resorting to its global scheduling, i.e. independent from the syntonized channel, in the absence of extra information held in the active interruption signal. At each transmission of each stored content, the device (102A . . . N) increments and/or updates the scheduling data for the purpose of synchronization and attribution of preferences (942), while continuously testing for the presence of the interruption signal in order to return to the regular transmission in its absence. Note that the existence and absence of this interruption signal should be understood in an ample sense. For implementation effects, it can be substituted for a start and finish interruption signal resorting to teletext, non audible acoustic signals, perceptive or not visual information, extra information on the available or non-used band's width, and/or any of the above combined.

In any of the modes described above, each device (102A . . . N) updates the scheduling data whenever necessary (950).

Note that any alteration in the channel's syntonization can cause a change of state in the device (102A . . . N) either because of the interruption signal's disappearance when present in the channel before syntonized, or because of the appearance or occurrence of another interruption signal in the new syntonized channel, causing it to act accordingly.

### Example of Resource Sharing

Focusing on FIG. 10, the processes and methods related to an incorporation of the Invention adapted to one or more radio and/or television transmitters are observable in more detail.

In this example, for simplifying reasons, a series of transmitters (1001A . . . N) broadcasting in an open or closed signal, diffused by ether, cable, satellite, internet, intranet, etc., being each one linked simultaneously to a public network such as the Internet or to a private network such as W-LAN (1010A). Also for simplifying reasons a number of devices (1002A . . . N), (1003A . . . N), (1004A . . . N) and (1005A . . . N) are acknowledged, deferring from each other due to: not incorporating the Invention (1002A . . . N), incorporating the Invention internally (1003A . . . N) and incorporating the Invention externally (1004A . . . N) by resorting to an auxiliary device (1005A . . . N). Also for simplifying reasons, let us admit that any one of the devices (1001A . . . N) is transmitting a certain programme, such as, for example, a football match, and all the receptors (1002A . . . N), (1003A . . . N), (1004A . . . N) are syntonized to that channel. Note that these presuppositions should on no account be understood as restrictions on the Invention considering that any other situation and/or group of presuppositions can easily be inferred without injury to the functions.

During the transmission of the first half of the mentioned match, all of the mentioned devices (1002A . . . N), (1003A . . . N) and (1004A . . . N) transmit the same received signal, in other words, the match at hand.

At the end of the match's first half, the transmitter sends out an interruption signal, via teletext page, for example, containing the scheduling index to be executed, marking the beginning of the commercial break which will produce the following results in the diverse sets of devices: no effect is produced in the devices (1002A . . . N) considering that these devices do not incorporate the Invention and therefore continued to reproduce the regular signal received from the transmitter.

The devices (1003A . . . N) and (1004A . . . N), in the latter's case via devices (1005A . . . N), suspend the regular broadcast partially or totally and go on to transmitting each one's stored contents according to each one's respective scheduling. At the end of the commercial break, the transmitter suspends the transmission of the interruption signal, via teletext page, for example, causing all the devices (1003A . . . N) and (1004A . . . N), in the latter's case via devices (1005A . . . N), and logically the devices (1002A . . . N), to transmit the regular broadcast in the same way, i.e. the second half of the mentioned football match. Note that if when a certain device (1003A . . . N) or (1004A . . . N) receives an interruption signal, there is no content to transmit according to the scheduling, for that channel or global, that device (1003A . . . N) or (1004A . . . N) will ignore the respective interruption and will continue to reproduce the regular signal, without any effect being produced, proceeding at that time as a device (1002A . . . N).

Throughout this detailed description, certain functions were mentioned, such as, storing contents and/or schedules. This should be understood in its most embracing form. It may not be a physical storage of the contents and/or schedules themselves, but rather hyperlinks or any other references to the contents themselves and respective schedules. Furthermore, in this description, terminologies such as advertisers, publicity, contents, messages, informative programmes, etc., were used, which should be understood in their more embracing forms and not as limitations to the Invention.

Details, explanations and examples were included in this description. This should be understood merely for comprehension purposes. No limitation to the Invention should be inferred from any of them. Many alterations can be made without however abandoning the Invention's spirit, basis and field.

1. Operating method for shared publicity, which comprises a set of systems for the attainment, validation, distribution and broadcasting of information/contents, wherein resorting to a set of devices capable of receiving regular transmissions from various transmitters in open or closed signals, retransmitting them in real time while receiving and storing sound and/or image information from each of them and/or from third parties, devices to analyse the regular signal for interruption and recover its retransmission, devices to transmit by overlapping totally or partially the stored image and/or sound information and return devices to control their broadcasting, where:
a user (105A . . . N; 106A . . . N) selects the electronic devices (102A . . . N) where he wishes to broadcast an advertising campaign defining its duration and characteristics, the mentioned selection is carried out through a server's (101A) access portal to which both the user and the electronic devices are linked;
the mentioned server (101A) informs the user (105A . . . N; 106A . . . N) of the campaign's cost and asks for his confirmation;
the mentioned user (105A . . . N; 106A . . . N) sends the campaign's content to the server (101A), this content is submitted to validation according to norms that have been predefined by the validators (104A . . . N), that are also linked to the server (101A);
once the content is accepted, the server sends it to the electronic devices along with data on the campaign's duration and characteristics;
the electronic devices (102A . . . N) produce the selected campaign;
the server (101A) gathers information about the campaign's progress and generates and sends or makes available for the user (105A . . . N; 106A . . . N) reports on the occurring campaign.

2. Operating method for shared publicity, according to claim 1, wherein the mentioned server (101A) comprises:
an interface module (211) with the user (105A . . . N; 106A . . . N) which allows any entity to consult the electronic devices' (102A . . . N) lists and their characteristics, to select those that are of his interest and to simulate a campaign on them;
an advertiser's interface module (212) which allows the advertisers (103A . . . N), (112A . . . N), (113A . . . N), (114A . . . N) to insert new campaigns, consult, change, remove occurring campaigns and/or consult reports on them;
a Web search engine's interface module (213) which allows other systems to connect and/or integrate the method itself as if they were a part of it;
an expositors interface module (214) which allows the devices' (102A . . . N) owners or lodgers to consult the occurring campaigns on their own devices;
a validators (104A . . . N) (215) interface module which allows the users registered as such to access their validation lists and to proceed to their voting;
a control module (221) which has the responsibility of managing the process as a whole;
a communications module (222) which controls the communications, distribution of contents, distribution of schedules and gathering of reports from all the devices (102A . . . N);
a research module (223) which allows the consultation and access of all databases and simultaneously provides the auxiliary tools for the selection of devices, contents, consultation of the history record and advertisers;
a scheduling module (224) which controls the schedules of all the devices (102A . . . N) and the collisions between themselves;
a report module (225) which organises and distributes all the reports obtained from the devices (102A . . . N) by their respective intervenients;
a financial module (226), which controls the financial flux between all of the intervenients in the process, by receiving and making payments among them.

3. Operating method for shared publicity, according to claim 1, wherein the mentioned server (101A) also comprises:
a devices' database (231) with all the devices (102A . . . N) and their characteristics;
an attributes' database (232) with all the devices' (102A . . . N) attributes and characteristics of their surroundings;
a contents database (233) where all the advertisers' (103A . . . N), (112A . . . N), (113A . . . N), (114A . . . N) or users' (105A . . . N), (106A . . . N) sent contents are stored;
a validations' database (234) where all the validators' (104A . . . N) validations made are stored;
a validators' database (235) where all the validators (104A . . . N) and their characteristics are stored;
an advertisers' database (236) where all the data referring to the advertisers is stored;
a historic database (237) used to store, consult and analyse past campaigns;
a financial database (238) where each intervenients' account is created and kept, from the advertisers to the exhibitors, including the validators and all the intervenient users in the process.

4. Operating method for shared publicity, according to claim 1, wherein the mentioned electronic devices included a part or all of the following modules:
a video output module (301) which allows the emission of static, dynamic or any other type of images, including holographic images;
an audio output module (302) which allows the emission of sounds, music or any other acoustic form;
a print output module (303) which allows the emission of coupons or of another incentive, on paper or any other form;
a message receivers interface module (304) which allows these to interact with the device (102A . . . N), providing or gathering any kind of additional information;
an interface with other devices module (305) which allows the device (102A . . . N) to communicate with the receivers' devices or devices that exist on site, providing or receiving additional information, depending on the case, in order to maximize the impact on the observer as well as the information returned to the advertisers (103A . . . N), (112A . . . N), (113A . . . N), (114A . . . N);
a control module (310) which is responsible for the whole process' management that takes place in the mentioned electronic device (102A . . . N), the mentioned module can also handle the sharing of resources' management with other functions for which the device is destined;
a communications module (311) which controls the communications, content reception, scheduling reception and sending of reports to and from the server (101A) and also allows the devices (102A . . . N) to function in collaboration with the server (101A) in the distribution of contents and schedules in a distributed manner, functioning as content and schedule repositories, re-distributing these to other devices (102A . . . N) and allows the creation of sub device (102A . . . N) networks that also function together with the server (101A);
a scheduling module (312) which controls the received schedules, guaranteeing that this is processed in the correct manner and that it functions in direct cooperation with the control module (310) in order to guarantee not only that the schedules are guaranteed, like in the cases of shared resources and which is synchronized with the occurring transition, interruption and recovery signals and/or their absence;
a storage module (313) which functions as a repository of contents and received schedules;
A supervision module (314) which allows certain special control actions on the device, for example its activation in the system, a forced stop due to the inconformity of the contents and other actions inherent to the device's physical functioning;
a reports module (315) which generates and sends all the reports to the server (101A);
a historical module (316) which stores all of the other modules' generated events in order to keep the device's own historical record; and
an actualization module (317) which allows the devise to update the information it contains, as well as itself if necessary.

5. Operating method for shared publicity, according to claim 1, wherein the user (105A . . . N; 106A . . . N) starts (501) the operating method by accessing (502) the server (101A)) through an access portal in order to select (503) one or more devices (102A . . . N) of his interest, this selection is assisted by various research tools, and to select (504) the sought campaign's duration and characteristics.

6. Operating method for shared publicity, according to claim 1, wherein whenever the user (105A . . . N; 106A . . . N) validates the cost indicated by the server (101A) for the campaign, the server (101A) requests the mentioned user's personal information and registers them and/or grants access to his personal area depending if he is a new user (520) or an already existing one (530), allowing the user to send (540) his content to the server (101A) and/or select among those sent by him before and/or marked as public in the server's (101A) contents database, these contents are validated by the validators (104A . . . N) and sent to the electronic devices (102A . . . N).

7. Operating method for shared publicity, according to claim 1, wherein the validation by voting of contents consists in the server (101A) making the validation lists reach (702) the respective validators (104A . . . N), the mentioned validators proceed to viewing and pronouncing themselves on them, accepting or rejecting them, or not pronouncing themselves on each of the contents on their lists, in the mentioned two last cases, they indicate the reasons for their choice (703), the mentioned same lists are then returned to the server (101A) together with each validators' (104A . . . N) individual vote (704) so that the mentioned server (101A) can conclude the validation process by confronting the different validators' (104A . . . N) validations for the same content according to the validation process.

8. Operating method for shared publicity, according to claim 1, wherein each device (102A . . . N) connects itself automatically in predefined time intervals to the server (101A), downloading from it, or from who the server indicates, the respective contents and schedules (802) in order to allow broadcasting the contents based on their schedules (804), sharing the space, time and resources among themselves, according to the respective scheduling.

9. Operating method for shared publicity, according to claim 1, wherein each device (102A . . . N) can itself make adjustments, if necessary, to the contents according to its own physical characteristics (803).

10. Operating method for shared publicity, according to claim 1, wherein if due to the broadcasting of the contents or to the scheduling itself, errors occur (805) these are treated by the device (102A . . . N) as exceptions (810) and reports about them are generated.

11. Operating method for shared publicity, according to claim 1, wherein the device generates reports about all the correctly processed broadcasts and about any other type of information that results from the interaction with observers or other third-party devices, to which it also attaches those that resulted from the treatment of exceptions and sends (811) them to the server (101A) so that it can forward them to the various intervenients according to each report.

12. Operating method for shared publicity, according to claim 1, wherein the broadcasting of contents is processed in each device (102A . . . N) either in an exclusive regime (910) or in a sharing of resources regime (920), the mentioned processing mode is defined for each device (102A . . . N), being part of their own characteristics.

13. Operating method for shared publicity, according to claim 1, wherein whenever the device (102A . . . N) is in an exclusive regime (910), it transmits the stored contents continuously, according to the respective scheduling, without interruptions or sharing with any other aim other than following its own scheduling, the mentioned scheduling may suspend, activate, deactivate and/or restart the broadcasting if such was defined, this device gathers and saves after each respective broadcast, the current state, point where it is, success or failure, in order to guarantee that the schedule is kept to and the broadcasting is well accomplished (950).

14. Operating method for shared publicity, according to claim 1, wherein whenever the device (102A . . . N) is in a sharing of resources regime (920), it continuously tests the received signal, i.e. syntonized, to detect interruption signals included in it.

15. Operating method for shared publicity, according to claim 14, wherein the interruption signals are sent via teletext, non-audible acoustic signals or others comprised in the syntonized signal.

16. Operating method for shared publicity, according to claim 15, wherein if no interruption signal is active, the device (102A . . . N) transmits the content of the regular signal (930) normally being able to simultaneously gather information on it (931) and if an interruption signal is active, the device (102A . . . N) automatically synchronizes its scheduling (940) in order to concur with the occurring transmission, interrupting and/or overlapping the stored contents on the regular received signal (941), in conformity with its scheduling (942) by resorting to the information contained in the interruption signal to synchronize with it.

17. Operating method for shared publicity, according to claim 14, wherein for each transmission of each stored content, the device (102A . . . N) increments and/or updates the scheduling data for the purpose of synchronization and attribution of preferences (942), while continuously testing for the presence of the interruption signal in order to return to the regular transmission in its absence.

18. Operating method for shared publicity, according to claim 15, wherein any alteration in the channel's syntonization can cause a change of state in the device (102A . . . N) either because of the interruption signal's disappearance from the channel syntonized before, or because of the appearance or occurrence of an interruption signal in the new syntonized channel.
